(19) United States
(12) Patent Application Publication
(10) Pub. No.: US 2016/0131306 A1
(43) Pub. Date: May 12, 2016

(54) MOTION DETECTION DEVICE AND EXERCISE APPLIANCE

(71) Applicant: SEIKO EPSON CORPORATION, Tokyo (JP)

(72) Inventor: Yuya ISHIKAWA, Chino-shi (JP)

(21) Appl. No.: 14/933,177

(22) Filed: Nov. 5, 2015

(30) Foreign Application Priority Data
Nov. 12, 2014 (JP) 2014-229769

(51) Int. Cl. F16M 13/02; F16B 1/00; F16B 2/22; A63B 24/00

(52) U.S. Cl. CPC F16M 13/022; A63B 24/0003; F16B 1/00; F16B 2/22; F16B 2001/0064; F16B 2001/0092

(57) ABSTRACT

A motion detection device includes a sensor that detects a motion, and a holder that attaches the sensor to an object to be measured, in which the holder is provided with a first terminal and a second terminal that are electrically connected to the sensor when the sensor is attached, and a wiring that connects the first terminal to the second terminal.

### BACKGROUND

1. Technical Field

The present invention relates to a motion detection device and an exercise appliance.

2. Related Art

As a method of analyzing and evaluating swing motions of a golf club, a baseball bat, or rackets of tennis and the like, and a human body which handles such an exercise appliance, a method of performing analysis on the basis of an image captured by a camera is known. There is an accuracy limit in the analysis using an image, and thus it is attempted to perform motion analysis with higher accuracy by using an acceleration sensor, a gyro sensor, or the like. For example, JP-A-11-169499 discloses a swing analysis device in which a sensor which can measure acceleration in three axes is attached to a grip of a golf club, and a swing is analyzed.

There are various methods of attaching a sensor to a target object such as an exercise appliance depending on purposes or shapes. Any sensor is required to be correctly fixed so as not to undergo positional deviation or dropping-out when the target object is moved.

However, it is expected that there is a user who uses (for example, swings) the target object without confirming that the sensor is reliably fixed, and there is a concern that the sensor may be dropped out or be positionally deviated depending on users during using of the target object.

### SUMMARY

An advantage of some aspects of the invention is to provide a holder which prompts a sensor to be reliably fixed to a target object and is thus unlikely to cause dropping-out or a positional deviation of the sensor during using of the target object. Another advantage of some aspects of the invention is to provide a motion detection device and an exercise appliance which is unlikely to cause dropping-out or a positional deviation of a sensor.

The invention can be implemented as the following forms or application examples.

### Application Example 1

This application example is directed to a motion detection device including a sensor that detects a motion; and a holder that attaches the sensor to an object to be measured, in which the holder is provided with a first terminal and a second terminal that are electrically connected to the sensor when the sensor is attached, and a wiring that connects the first terminal to the second terminal.

According to the motion detection device, it is possible to easily determine whether or not the sensor is attached to the object to be measured by checking conduction by using the first terminal and the second terminal. Consequently, a user can check whether or not the sensor is reliably attached to the object to be measured, and thus the user can easily check whether or not attachment is favorably performed. Thus, it is possible to hardly cause dropping-out or a positional deviation of the sensor during using of the object to be measured.

### Application Example 2

In the motion detection device according to Application Example 1, the holder may include a notification unit, and the notification unit may send a notification of an attachment state of the sensor.

The motion detection device according to this application example can easily notify a user whether or not the sensor is reliably attached to the object to be measured.

### Application Example 3

In the motion detection device according to Application Example 2, the notification unit may change a notification due to a potential difference between the first terminal and the second terminal when the sensor is attached.

The motion detection device according to this application example can electrically recognize whether or not the sensor is reliably attached to the object to be measured.

### Application Example 4

In the motion detection device according to Application Example 2 or 3, the notification unit may send a notification of the attachment state of the sensor through light emission.

The motion detection device according to this application example can visually notify a user whether or not the sensor is reliably attached to the object to be measured.

### Application Example 5

In the motion detection device according to any one of Application Examples 1 to 4, each of the sensor and the holder may include fitting portions which are fitted to each other.

According to the motion detection device according to this application example, it is possible to check whether or not the holder and the sensor are reliably fitted to each other. Thus, it is possible to hardly cause dropping-out or a positional deviation of the sensor during using of the object to be measured.

### Application Example 6

In the motion detection device according to Application Example 5, the holder may be fastened when the sensor is fitted thereto, and may thus be fixed to the object to be measured.

The motion detection device according to this application example is easily attached to the object to be measured and fastens the object to be measured through fitting, and can thus be more firmly attached to the object to be measured.

### Application Example 7

This application example is directed to an exercise appliance attached with the motion detection device according to any one of Application Examples 1 to 6.

According to the exercise appliance, a user can easily determine whether or not the sensor is reliably attached to the object to be measured, and thus the user can easily check whether or not attachment is favorably performed. Thus, it is possible to hardly cause dropping-out or a positional deviation of the sensor.

### BRIEF DESCRIPTION OF THE DRAWINGS

The invention will be described with reference to the accompanying drawings, wherein like numbers reference like elements.

FIG. 1 is an exterior perspective view illustrating a state in which a holder according to an embodiment is attached to an exercise appliance (golf club).

FIG. 2 is an enlarged view of a region indicated by A in FIG. 1, and is a schematic diagram illustrating a state in which a sensor is being fitted to the holder according to the embodiment.

FIG. 3 is an enlarged view of the region indicated by A in FIG. 1, and is a schematic diagram illustrating the exercise appliance with sensor in a state in which the holder according to the embodiment is attached to the exercise appliance, and the sensor is fitted to the holder.

FIG. 4 is a perspective view illustrating the holder according to the embodiment, and is a perspective view which is viewed from an arrow direction indicated by J in FIG. 12.

FIGS. 5A and 5B are schematic diagrams illustrating examples of a first terminal, a second terminal, and a wiring provided in the holder according to the embodiment.

FIG. 6 is a schematic diagram in which the sensor according to the embodiment is viewed from the top in a planar manner.

FIG. 7 is a schematic diagram in which the sensor according to the embodiment is viewed from the bottom in a planar manner.

FIG. 8 is a schematic diagram in which the sensor according to the embodiment is viewed from an arrow direction indicated by F in FIG. 6.

FIG. 9 is a schematic sectional view in which the sensor according to the embodiment is cut along the line B-B′ in FIGS. 6 and 7.

FIG. 10 is a schematic sectional view in which the sensor according to the embodiment is cut along the lines C-C′ and E-E′ in FIGS. 7 and 8.

FIG. 11 is a schematic diagram in which the holder according to the embodiment is viewed from an attachment surface side in a planar manner.

FIG. 12 is a schematic diagram in which the holder according to the embodiment is viewed from an arrow direction indicated by G in FIG. 11.

FIG. 13 is a schematic diagram in which the holder according to the embodiment is viewed from an arrow direction indicated by H in FIG. 11.

FIG. 14 is a schematic sectional view illustrating a state in which the holder according to the embodiment is attached to the exercise appliance (golf club).

FIG. 15 is a schematic sectional view illustrating a state in which the sensor is fitted to the holder according to the embodiment.

FIG. 16 is an enlarged view of a region indicated by J in FIG. 15.

FIG. 17 is a schematic sectional view taken along the line L-L′ in FIG. 16.

FIG. 18 is a schematic sectional view taken along the line M-M′ in FIG. 17.

FIG. 19 is a schematic enlarged view illustrating an operation state of a pressing protrusion.

FIGS. 20A to 20D are schematic diagrams illustrating some examples of exteriors of a direction indicator in the sensor.

FIGS. 21A to 21C are schematic diagrams of some circuit configurations in a case where a light emitting diode is provided in the holder.

FIG. 22 is an exterior view illustrating an exercise appliance with sensor and a motion analysis apparatus according to the embodiment.

FIG. 23 is a block diagram illustrating the motion analysis apparatus according to the embodiment.

### DESCRIPTION OF EXEMPLARY EMBODIMENTS

Hereinafter, some embodiments of the invention will be described. The embodiments described below are to describe an example of the invention. The invention is not limited to the following embodiments, and includes various modification examples which occur within the scope without departing from the spirit of the invention. All constituent elements described below are not essential constituent elements of the invention.

### 1. Holder

A holder of the present embodiment has a curved plate shape with an open portion, and is attached to an object to be measured so as to hold the object to be measured by fitting the object to be measured into the open portion. The holder of the present embodiment includes a first terminal and a second terminal which are respectively provided on both-end sides of the open portion, and a wiring which electrically connects the first terminal and the second terminal to each other. The holder is a tool or an attachment for attaching a sensor to be described later to the object to be measured.

### 1.1 Object to be Measured

A description will be made of the object to be measured to which the holder and the sensor are attached. The object to be measured to which the holder of the present embodiment is attached has a shape which can be held, such as a bar shape, a columnar shape, a tubular shape, and is not limited as long as the object performs independent or passive motions (a spatially positional movement, a change in a shape or an attitude, rotation, vibration, and the like). Such an object to be measured may include appliances or tools used in various sports, for example, a golf club, a baseball bat, rackets of tennis and the like, and a bamboo sword, and objects other than the appliances or tools, for example, parts of the human body such as arms or legs, or a movable portion such as an arm of a robot apparatus.

Hereinafter, a description will be made of a case where the object to be measured is a golf club. Regarding the golf club, although not particularly limited, a golf club in which a rubber grip is attached to a shaft thereof will be described. In the description thereof, an aspect in which the holder of the present embodiment holds the rubber grip portion will be described, but the holder may hold the shaft or may hold a boundary therebetween.

### 1.2 Shape of Holder

The holder has a curved plate shape with an open portion. The holder has a shape which holds a bar-shaped object to be measured. The holder is attached to the object to be measured by holding the object to be measured. More specifically, the holder holds the object to be measured by fitting the object to be measured into its open portion. A holder 20 of the present embodiment holds a golf club 200 (object to be measured). The holder 20 may include other members (for example, a mechanism fixing a sensor 10).

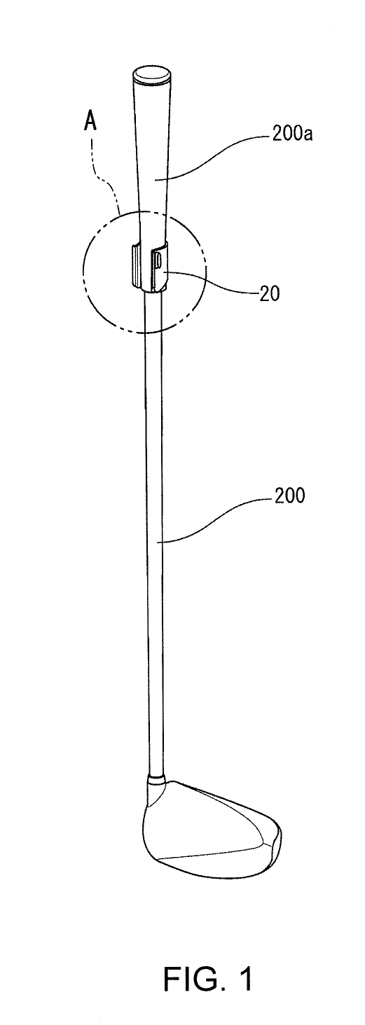

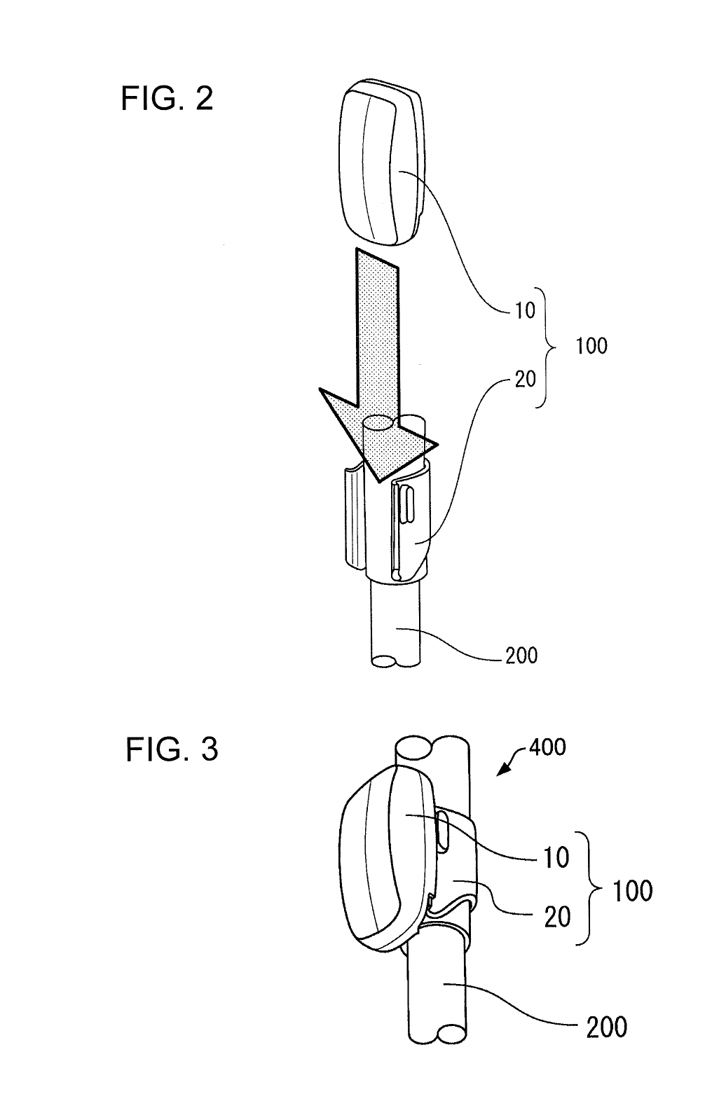

FIG. 1 is an exterior perspective view illustrating a state in which the holder 20 according to the present embodiment is attached to the golf club 200 (exercise appliance). FIG. 2 is an enlarged view of a region indicated by A in FIG. 1, and is a schematic diagram illustrating a state in which the sensor 10 is being fitted to the holder 20 according to the present embodiment. FIG. 3 is an enlarged view of the region indicated by A in FIG. 1, and is a schematic diagram illustrating a state in which the sensor 10 is fitted to the holder 20 according to the present embodiment.

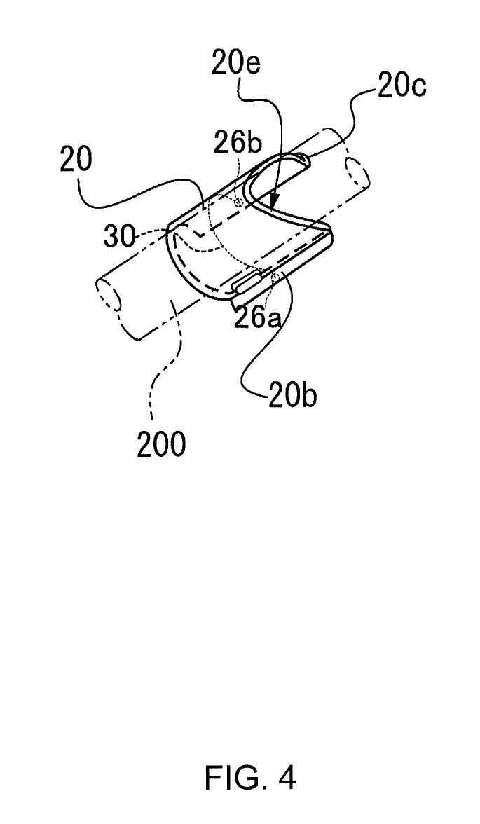

As illustrated in FIG. 1, the sensor 10 including a sensor unit 13 (not illustrated) such as an inertial sensor is attached to the holder 20 which can be attached to a grip portion 200a of the golf club 200, via fitting portions 20b and 20c illustrated in FIG. 4 in an arrow direction illustrated in FIG. 2. Thus, the sensor 10 is attached to the golf club 200 as illustrated in FIG. 3.

As illustrated in FIG. 3, a motion detection device 100 (including the holder 20 and the sensor 10 fitted to the holder 20) according to the present embodiment is attached to the golf club 200 as a motion body which is moved. In other words, in a case where the holder 20 is attached to the golf club 200 and thus the fitting portions 20b and 20c are fitted to the sensor 10, the sensor 10 is attached to the golf club 200 so as to surround the golf club 200.

Here, in the present specification, the phrase, “the holder holds an object to be measured”, indicates that the holder is attached and fixed to (holds) the object to be measured so as to grasp (clutch or grip) the object to be measured having a bar shape, a columnar shape, or a tubular shape, and indicates a state in which the holder is fixed (supported) thereto so as not to cover the entire circumference of the object to be measured but to cover at least a half circumference of the object to be measured. Such an aspect may be replaced with a phrase, “the holder grips the object to be measured” or “the holder is attached to the object to be measured so as to grip the object to be measured”.

The holder holds the object to be measured by fitting the object to be measured into the open portion thereof. The open portion indicates a portion in which a part of a tube having a tubular shape is cut out in an extending direction of the tube so that the curved plate-shaped holder 20 is obtained (refer to an attachment opening 20k of FIG. 14). In other words, the open portion is an insertion gap when the holder 20 holds the object to be measured having a bar shape. Hereinafter, portions of the holder 20 forming edges of the open portion are referred to as opening ends of the holder 20 in some cases, and two opening ends (a pair) are present in the holder 20 of the present embodiment.

A material of the holder 20 is not limited as long as a biasing force for holding the golf club 200 is obtained, but, for example, synthetic resin such as polyethylene, polypropylene, polystyrene, polyvinyl chloride, polycarbonate, ABS resin, fluorine resin, acrylic resin, or copolymers thereof may be used and the material can contribute to reduction in weight of the holder 20.

### 1.3 Fitting Portion

The holder 20 may be provided with the fitting portions 20b and 20c on tip end sides holding the object to be measured. The holding tip end sides are portions which are in the vicinity of the opening ends of the holder 20 and initially grasp the object to be measured when the holder 20 holds the object to be measured.

FIG. 4 is a perspective view illustrating the holder 20, and is a perspective view which is viewed from an arrow direction indicated by J in FIG. 12. The fitting portions 20b and 20c function as a configuration for fitting to the sensor 10 to be described later, for example. The fitting portions 20b and 20c can stably attach the sensor 10 to the golf club 200 so that the sensor 10 is unlikely to be dropped out, positionally deviated, or rotated.

A first terminal 26a and a second terminal 26b which will be described later are respectively provided in the fitting portion 20b and the fitting portion 20c. A shape of each of the first terminal 26a and the second terminal 26b provided in the fitting portions 20b and 20c is not particularly limited, but each of the terminals has a shape which enables electrical connection with a fourth terminal 16a and a fifth terminal 16b of the sensor 10 when the fitting portions 20b and 20c are appropriately fitted to the sensor 10. In the illustrated example, the first terminal 26a is provided in the fitting portion 20b, and the second terminal 26b is provided in the fitting portion 20c. As details of the fitting portions 20b and 20c will be described later, in a case where the holder 20 is attached to the golf club 200, and the fitting portions 20b and 20c are fitted to the sensor 10, the sensor 10 and the holder 20 (sensor set 100) are attached to the golf club 200 so as to surround the golf club 200. In a case where the fitting portions 20b and 20c are fitted to the sensor 10, the extent of biasing toward the golf club 200 may be made to be increased. In the above-described way, the sensor 10 can be stably attached to the golf club 200 so as to be unlikely to be dropped out, positionally deviated, or rotated.

In the present embodiment, there is an aspect in which the fitting portions 20b and 20c have a rail shape and are slid and fitted to the sensor 10 through insertion into grooves (grooves 11d and 11e) of the sensor 10, but the present embodiment is not particularly limited as long as the sensor 10 can be fixed to the golf club 200.

### 1.4 Sensor

The sensor 10 includes the fourth terminal 16a and the fifth terminal 16b which respectively come into contact with the first terminal 26a and the second terminal 26b of the holder 20. The fourth terminal 16a and the fifth terminal 16b are connected to a determination unit 140 provided in the sensor 10. The fourth terminal 16a and the fifth terminal 16b are electrically connected to the first terminal 26a and the second terminal 26b of the holder 20 via a wiring 30 when respectively coming into contact therewith.

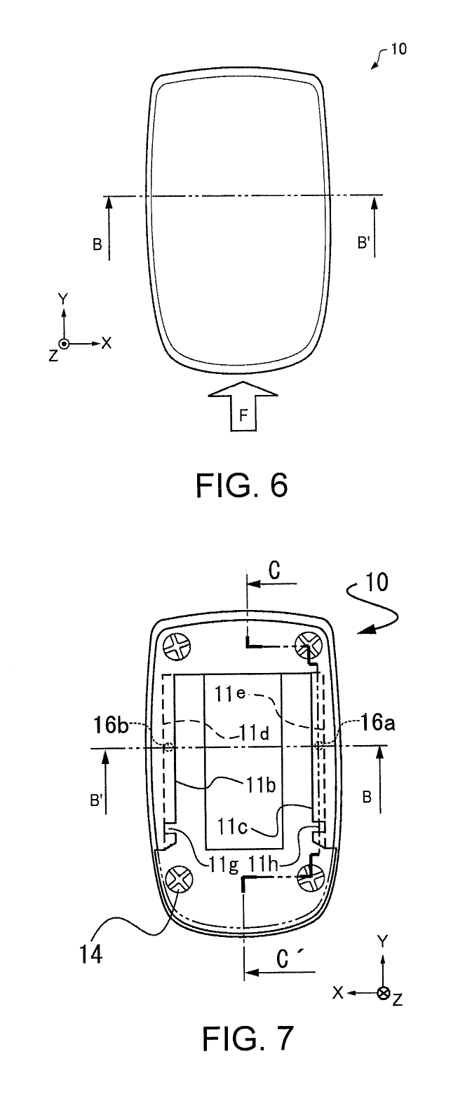

The sensor 10 will be described with reference to FIGS. 6 to 10. In FIGS. 6 to 10, the wiring or the like extending from the fourth terminal 16a is not illustrated. As illustrated in FIGS. 9 and 10, the sensor 10 includes a casing in which an internal space 10a is formed by a cover 12 which is fixed to a base 11 via screws 14. A sensor unit 13 as a detection unit of the sensor 10 is fixed to a surface 11a of the base 11 on the internal space 10a side in a method such as adhesion, and the sensor unit 13 is constituted of electronic devices 13b and a circuit board 13a on which the electronic devices 13b are mounted. At least one of the electronic devices 13b is an inertial sensor. The sensor unit 13 may include an acceleration sensor or an angular velocity sensor. The sensor unit 13 may be appropriately configured so as to analyze, for example, motions in three axes.

A method of fixing the cover 12 to the base 11 is not limited to the screws 14, and the cover 12 may be fixed to the base 11 through, for example, adhesion, and may be fixed to the base 11 through welding if the base 11 and the cover 12 are made of plastic.

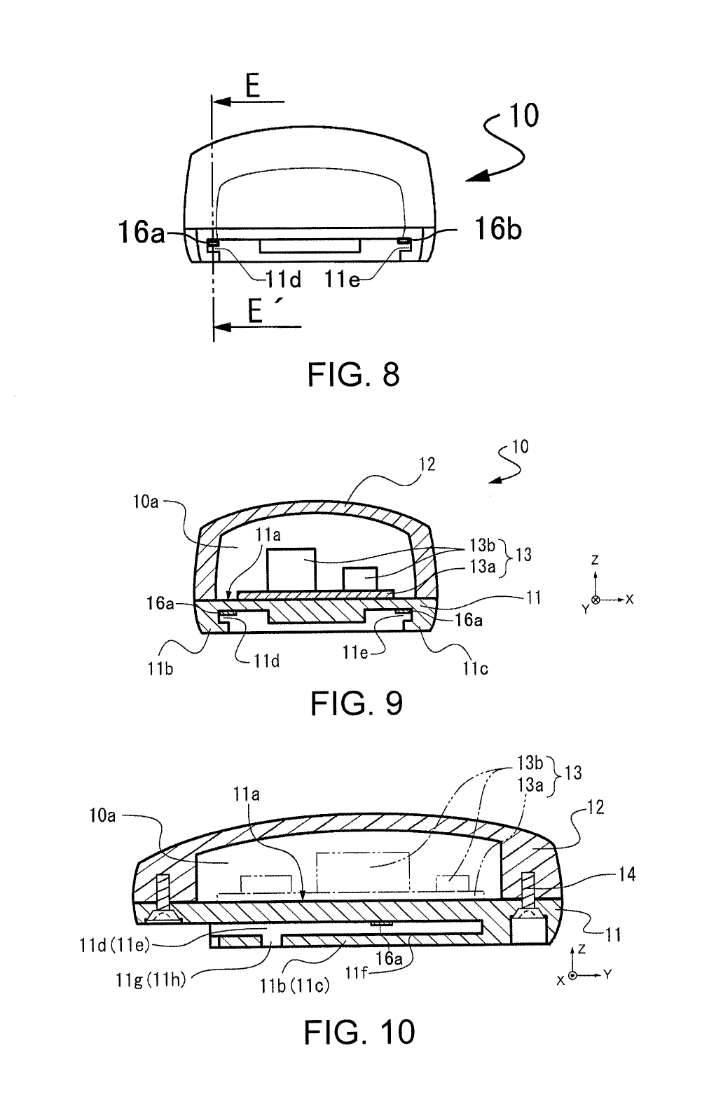

The base 11 is provided with a protrusion 11b and a protrusion 11c which extend so as to be in parallel to each other in the illustrated Y direction as illustrated in FIGS. 7 and 8. A groove 11d as a depression is formed in the protrusion 11b in the Y direction, and a groove 11e as a depression is also formed in the protrusion 11c in the Y direction. Openings of the groove 11d and the groove 11e in the X direction are formed so as to face each other. Sides of the groove 11d and the groove 11e in the −Y direction, that is, the sides in the direction in which the sensor 10 is installed, illustrated in FIG. 2, are open, and sides in the opposite direction are formed as a groove wall 11f (refer to FIGS. 9 and 10 together). Therefore, in the sensor 10, the groove 11d and the groove 11e constitute a fitting portion which is fitted to the holder 20. As engaging portions which are engaged with detachment prevention protrusions of the holder 20, a notch 11g is formed in the protrusion 11b, and a notch 11h is formed in the protrusion 11c.

The fourth terminal 16a and the fifth terminal 16b which will be described later are provided at the groove 11e and the groove 11d. Shapes of the fourth terminal 16a and the fifth terminal 16b provided at the grooves 11e and 11d are not particularly limited, but the terminals have shapes which enable electrical connection with the first terminal 26a and the second terminal 26b of the holder 20 when the fitting portions 20b and 20c are respectively fitted to the grooves 11d and 11e. In the illustrated example, the fourth terminal 16a is provided at the groove 11e, and the fifth terminal 16b is provided at the groove 11d.

The sensor 10 includes the determination unit 140. The determination unit 140 can determine whether or not both of the first terminal 26a and the second terminal 26b come into contact with the fourth terminal 16a and the fifth terminal 16b. The determination unit 140 may transmit or hold various signals corresponding to determination results.

### 1.5 Fitting and Assembling

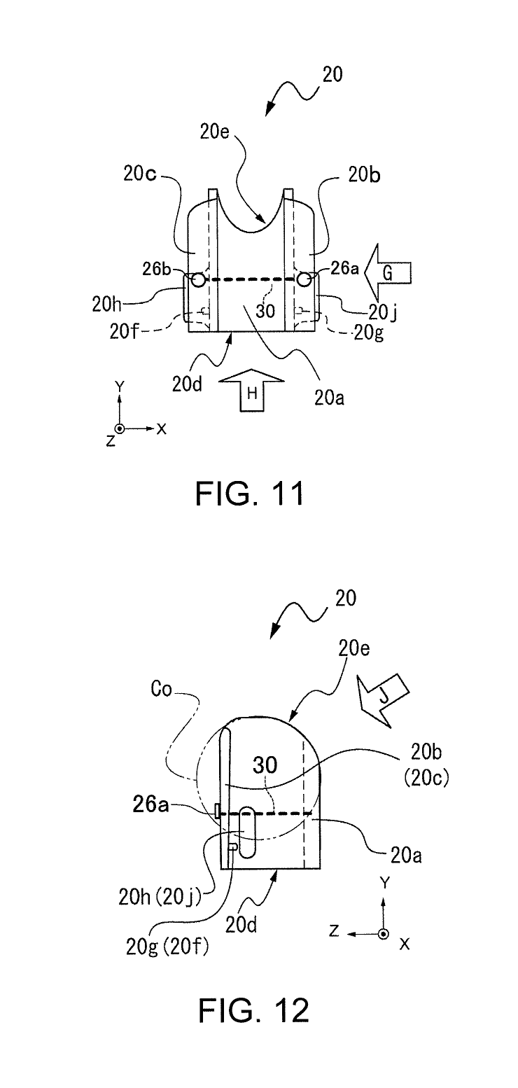

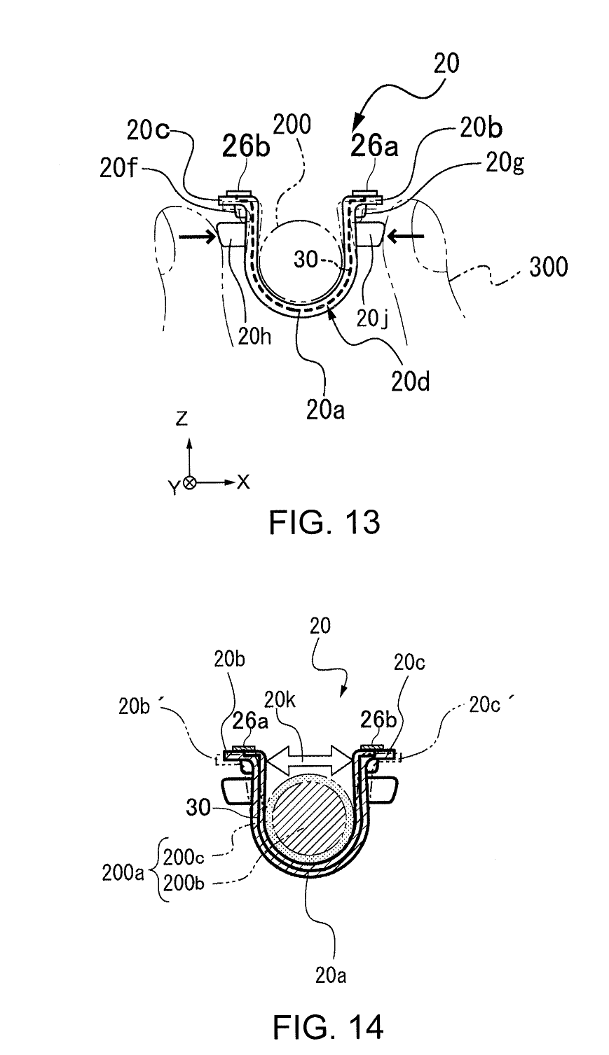

FIGS. 11 to 13 illustrate the holder 20, in which FIG. 11 is a plan view illustrating the related holder 20, FIG. 12 is a side view in which the holder 20 is viewed from an arrow direction indicated by Gin FIG. 11, and FIG. 13 is a side view in which the holder 20 is viewed from a direction indicated by H in FIG. 11.

As illustrated in FIG. 13, the holder 20 includes an attachment surface 20a which is wound on and attached to the golf club 200 as an object to be measured, the fitting portion 20b as a projecting portion which is inserted into the groove 11d of the sensor 10 illustrated in FIG. 2, projects in the −X direction, and extends in the Y direction, and the fitting portion 20c as a projecting portion which is inserted into the groove 11e, projects in the +X direction, and extends in the Y direction.

As illustrated in FIG. 12, one end 20d of the holder 20 in the ±Y direction is formed along an X-Z plane, but the other end 20e is formed in a shape along a circumferential plane Co intersecting the X-Z plane in this example. As a result, a planar shape of the other end 20e is a concave shape as illustrated in FIG. 11. The other end 20e is formed in the above-described way, and thus it is possible to realize a clear shape difference from the one end 20d. Therefore, for example, in a case where the sensor 10 fitted to the holder 20 has a function of designating a installation direction, the holder 20 is attached after the other end 20e having a different shape matches the golf club 200 as an indicator of the installation direction, and thus it is possible to prevent mistakes related to the installation direction of the sensor 10. The present embodiment is not limited to the configuration in which a shape of the other end 20e is different from that of the one end 20d, and a mark may be provided through simple marking or by using the wiring 30 which will be described later.

The holder 20 may be provided with detachment prevention protrusions 20f and 20g of the sensor 10. The detachment prevention protrusions 20f and 20g are engaged with the engaging portions (not illustrated) of the sensor 10 when the sensor 10 to be described later is installed, and thus prevent the sensor 10 from being separated from the holder 20. Since the detachment prevention protrusions 20f and 20g are provided, pressing protrusions 20h and 20j may be provided which cancel engagement of the detachment prevention protrusions 20f and 20g with the engaging portions of the sensor 10 when the sensor 10 is detached from the holder 20. When the sensor 10 is detached from the holder 20, the pressing protrusions 20h and 20j are pressed to an arrow direction with the fingers 300 as illustrated in FIG. 13 so that a distance between the detachment prevention protrusions 20f and 20g is reduced, and thus fitting to the fitting portions of the sensor 10 is removed. Therefore, the sensor 10 can be detached from the holder 20.

Next, a description will be made of a state in which the sensor 10 is installed in the holder 20. FIG. 14 is a sectional view illustrating a state in which the holder 20 is attached to the golf club 200. As illustrated in FIG. 14, the holder 20 is attached to the grip portion 200a of the golf club 200. The grip portion 200a has a configuration in which a shaft portion 200b is coated or wound with a nonslip grip rubber 200c. The grip rubber 200c is made of, for example, an elastic material such as rubber, urethane, or elastomer. A repulsive force which is generated due to compression with the shaft portion caused by the attachment surface 20a of the holder 20 (an inner surface of the holder 20) increases a frictional force between the holder 20 and the grip rubber 200c, and thus it is possible to prevent the holder 20 from being positionally deviated from the golf club 200.

A form in which the sensor set 100 according to the present embodiment is attached to the golf club 200 has been exemplified, but, for example, in a case where a nonslip portion is not provided at a grip portion, such as a baseball bat, an elastic member such as the grip rubber 200c in FIG. 14 may be interposed between the baseball bat and the attachment surface 20a of the holder 20, that is, the nonslip member may be disposed as a so-called interposed member. As a material of the interposed member, elastic resin such as rubber, urethane, or elastomer, or a soft metal is preferably used. The same effect can also be achieved by attaching a sheet of elastic resin to the attachment surface 20a (refer to FIG. 11) of the holder 20.

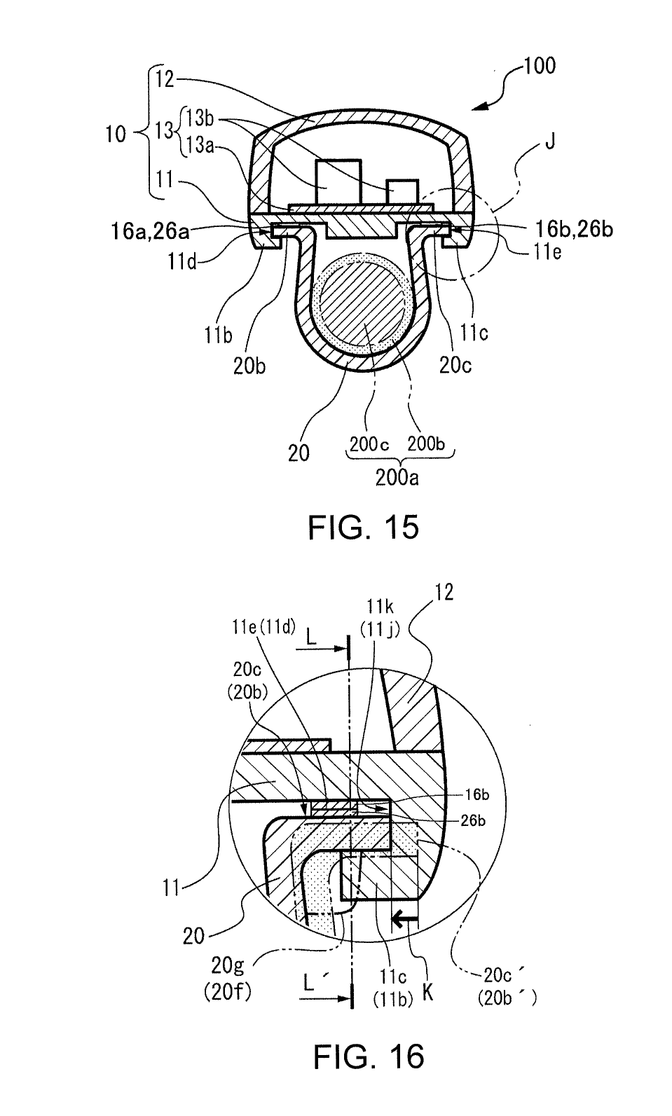

FIG. 15 is an assembly sectional view at a position corresponding to a B-B′ part illustrated in FIGS. 6 and 7 in a state in which the holder 20 is assembled with the sensor 10. Regarding assembling of the sensor set 100, the sensor 10 is moved to the holder 20 attached to the golf club 200 in an arrow direction as illustrated in FIG. 2, the fitting portion 20b and the fitting portion 20c included in the holder 20 are inserted specifically, slid and inserted into the groove 11d and the groove 11e formed in the sensor 10 as illustrated in FIG. 15, and thus the sensor 10 is attached to the holder 20 which is attached to the golf club 200 so that the sensor set 100 is assembled.

As illustrated in FIG. 14, if the holder 20 is attached to the grip portion 200a of the golf club 200, the grip rubber 200c of the grip portion 200a is interposed between the attachment surface 20a of the holder 20 and the shaft portion 200b. In this state, the attachment opening 20k opposing the attachment surface 20a is displaced so as to increase its width due to elasticity of the grip rubber 200c, and thus the fitting portion 20b and the fitting portion 20c enter states of a fitting portion 20b′ and a fitting portion 20c′ through outward movements thereof.

As illustrated in FIG. 15, the fitting portion 20b and the fitting portion 20c are inserted into the groove 11d and the groove 11e in the states of the fitting portion 20b′ and the fitting portion 20c′, and are thus corrected in a direction of an illustrated arrow K by a wall surface 11j of the groove 11e and a wall surface ilk of the groove 11e as illustrated in FIG. 16. In other words, in the state of the sensor set 100 illustrated in FIG. 15, the holder 20 is corrected in a direction of compressing the grip rubber 200c, and can thus increase a holding force of the grip portion 200a of the holder 20. Therefore, positioning of the sensor set 100 for the golf club 200 can be reliably performed, and thus a positional deviation is unlikely to occur due to an inertial force or an impact force which is applied to the sensor set 100 by swinging the golf club 200, and appropriate swing data of the golf club 200 can be acquired.

As illustrated in FIG. 15, if the fitting portion 20b and the fitting portion 20c are respectively inserted into the groove 11d and the groove 11e, the first terminal 26a and the second terminal 26b respectively come into contact with the fourth terminal 16a and the fifth terminal 16b so as to cause electrical connection therebetween.

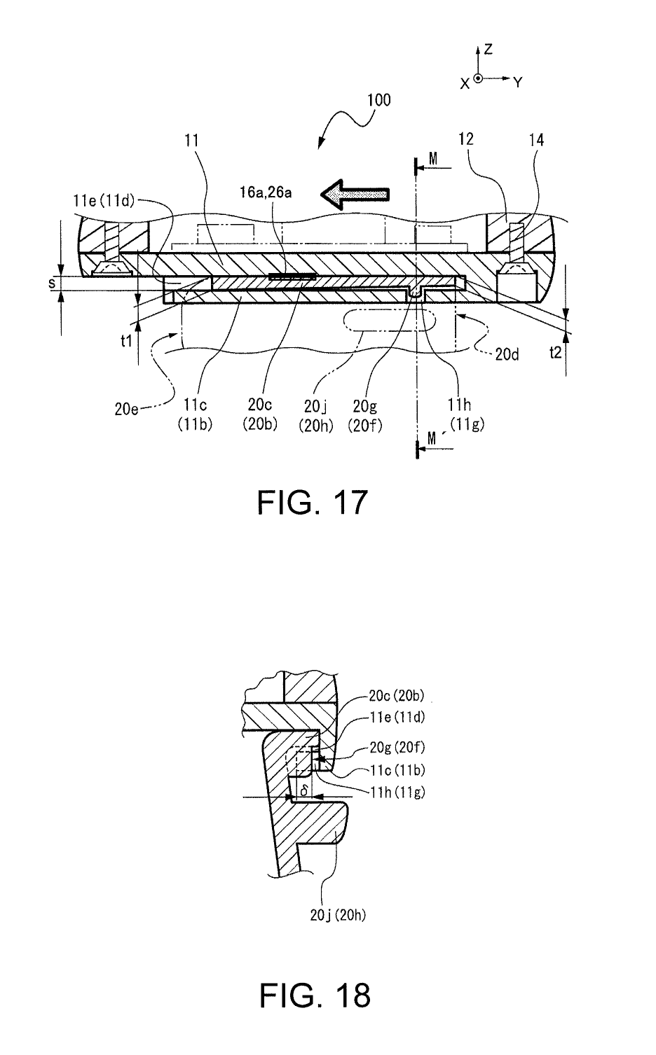

FIG. 17 is a schematic sectional view of an L-L′ part illustrated in FIG. 16. As illustrated in FIG. 17, the sensor 10 is moved in a direction of an illustrated arrow with respect to the holder 20 so that the fitting portion 20c of the holder 20 is relatively inserted into the groove 11e, and, similarly, the fitting portion 20b of the holder 20 is relatively inserted into the groove 11d, and thus the sensor set 100 can be assembled. The L-L′ part in FIG. 16 corresponds to the groove 11e and the fitting portion 20c, and, thus, hereinafter, the groove 11e and the fitting portion 20c will be described an example.

When the sensor 10 is inserted into the holder 20 in the direction of the illustrated arrow, first, the end of the fitting portion 20c on one end 20d side of the holder 20 starts being inserted into the groove 11e. A thickness (in the Z direction) t2 of the fitting portion 20c on one end 20d side is formed to satisfy t2<s for a height s of the groove 11e in the Z direction. In other words, the thickness of the fitting portion 20c on one end 20d of the holder 20 is made smaller than the height of the groove 11e, and thus installation can be easily performed when the insertion is started.

The fitting portion 20c is relatively further inserted into the groove 11e, and, as illustrated in FIG. 17, the detachment prevention protrusion 20g of the holder 20 is fitted to the notch 11h formed in the protrusion 11c, and thus the insertion is completed. In this state, if a thickness t1 of the fitting portion 20c on the other end 20e of the holder 20 has a relationship of t1>t2, a gap between the groove 11e and the fitting portion 20c in the Z direction is narrower on the other end 20e than on one end 20d of the holder 20. Thus, for example, in a condition of t1≅s or t1>s, the fitting portion 20c is nipped by the surface of the groove 11e in the Z direction, and thus it is possible to prevent the sensor 10 from being dropping out of the holder 20. Rattling of the sensor 10 in the Z direction for the holder 20 is minimized, and thus it is possible to obtain appropriate swing data of the golf club 200.

As illustrated in FIG. 15, the gap between the fitting portion 20b and the groove 11d, and the gap between the fitting portion 20c and the groove 11e are respectively formed to an extent in which the first terminal 26a and the fourth terminal 16a come into contact with each other, and the second terminal 26b and the fifth terminal 16b come into contact with each other. For example, the size of the gap between the fitting portion 20b and the groove 11d is about a sum of the thicknesses of the first terminal 26a and the fourth terminal 16a. The size of the gap between the fitting portion 20b and the groove 11d is appropriately designed so that the terminals are unlikely to be damaged, and both of the terminals can be electrically connected to each other. In the example illustrated in FIG. 15, the first terminal 26a and the second terminal 26b are formed on the curved plate-shaped surface of the holder 20, and the fourth terminal 16a and the fifth terminal 16b are formed on the surface of the sensor 10 directed toward the holder 20, but the first terminal 26a and the second terminal 26b may be formed on the curved plate-shaped end surface of the holder 20, and the fourth terminal 16a and the fifth terminal 16b may be formed on the bottom of the groove 11d of the sensor 10.

FIG. 18 is a schematically enlarged sectional view of an M-M′ part illustrated in FIG. 17. As illustrated in FIG. 18, the detachment prevention protrusion 20g is fitted to the notch 11h of the protrusion 11c with a fitting amount 6 in a state in which the fitting portion 20c is inserted into the groove 11e. Consequently, the attachment state between the sensor 10 and the holder 20 illustrated in FIG. 17 is maintained.

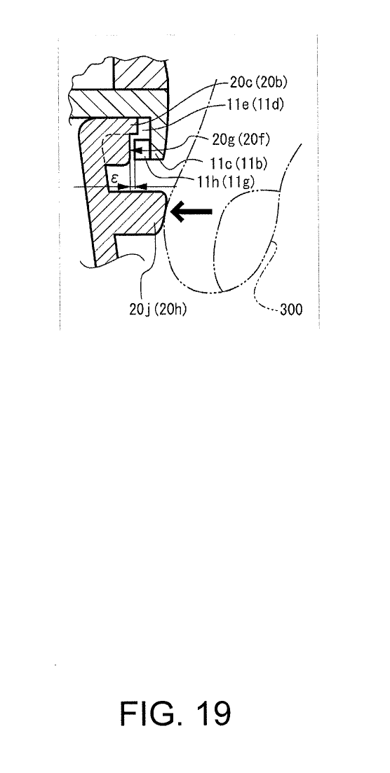

In a case where the sensor 10 is detached from the holder 20 in this state, as illustrated in FIG. 19, if the pressing protrusion 20j is pressed in a direction of an illustrated arrow, for example, with the fingers 300, the detachment prevention protrusion 20g is separated from the notch 11h so as to generate a gap ε (where ε>0), and, in this state, the sensor 10 is slid in a direction opposite to the arrow illustrated in FIG. 17. Therefore, the sensor 10 can be detached from the holder 20. As mentioned above, since the detachment prevention protrusions 20g and 20f, and the notches 11h and 11g to which the detachment prevention protrusions 20g and 20f can be fitted are provided, the sensor 10 can be reliably attached to the holder 20, and the sensor 10 can also be easily detached from the holder 20 as necessary.

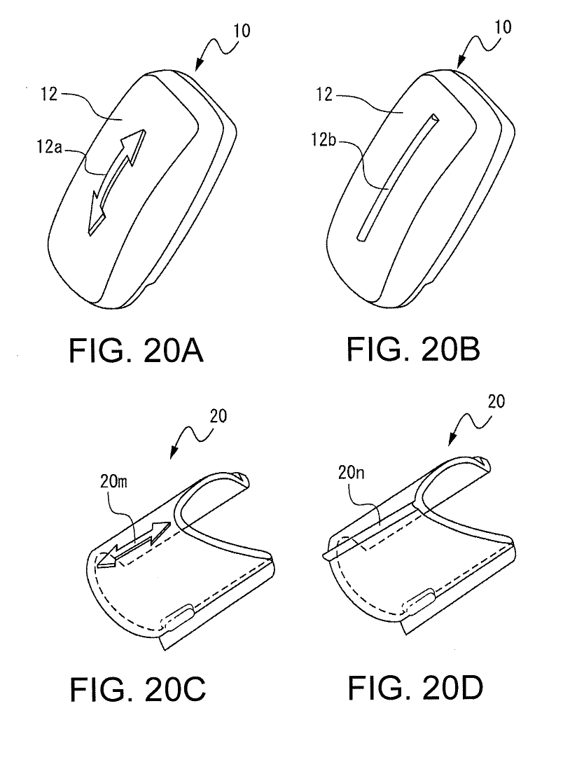

In a case where the electronic devices 13b provided in the sensor set 100 include an inertial sensor having a detection axis, the sensor set 100 is attached to the golf club 200, and, for example, the detection axis of the inertial sensor is positioned relative to the golf club 200. In this case, as a mechanism for clearly indicating a detection axis direction, detection axis direction indicators as illustrated in FIGS. 20A to 20D may be provided in the detection apparatus.

An aspect has been exemplified in which the direction indictors 12a, 12b, 20m and 20n illustrated in FIGS. 20A to 20D are all integrally formed with the protruding cover 12 or holder 20, but indicators are not limited thereto, and may have a concave shape formed through molding or engraving, or may be a printing mark. The indicators are not limited to an arrow shape or a linear shape, and may be marks having shapes which enable a direction to be identified.

If a direction indicator is provided in the holder 20, the wiring 30 to be described later may be used as the direction indicator (identification mark). For example, if the wiring 30 is extracted in a shape similar to an arrow shape or the golf club 200 and is visually recognized by a user, it is possible to display a desirable attachment direction to the user in an intuitively understandable manner. Instead of the protrusions indicated by the reference numerals 20m and 20n in FIGS. 200 and 20D, the wiring 30 may be provided in the same shape as those of the protrusions, and the wiring 30 may be disposed inside a corresponding protrusion so that a user can easily visually recognize the protrusion.

As other modification examples, for example, if the detection axis of the inertial sensor is set in a direction in which the groove or the fitting portion extends without providing the direction indicator, the detection direction can be made to match a predetermined direction only by performing an operation of fitting the base and the holder to each other, and thus it is possible to detect a motion with high accuracy. For example, if an angular velocity sensor is used as the inertial sensor, and an axial direction is set to the direction in which the groove or the fitting portion extends, angular velocity about a shaft axis can be detected with high accuracy, and thus it is possible to trace a change or the like in a face angle of a golf club head with high accuracy.

In the above-described sensor set 100, the sensor 10 can be easily attached to the holder 20 which is attached to the golf club 200 only by sliding and fitting the sensor 10 so that the rail-shaped fitting portions 20b and 20c provided in the holder 20 are inserted into the grooves 11d and 11e provided in the sensor 10. Therefore, the first terminal 26a and the fourth terminal 16a can be electrically connected to each other.

Since the sensor 10 is attached to the holder 20, the grip rubber 200c provided in the grip portion 200a is compressed and interposed between the attachment surface 20a of the holder 20 and the shaft portion 200b so that a holding force of the sensor set 100 for the golf club 200 can be increased, and thus it is possible to minimize a deviation of the attachment position due to an inertial force or an impact force which is applied to the sensor set 100 as a result of swinging the golf club 200. Therefore, it is possible to obtain appropriate swing data of the golf club 200.

In addition to the slide-fitting structure, there may be a structure in which the base and the holder are fitted to each other through mutual compressions by providing a depression such as a groove or a hole in one of the base and the holder and providing a projecting portion such as a protrusion in the other of the base and the holder. Even if any fitting method is selected, the first terminal 26a, the second terminal 26b, the fourth terminal 16a, and the fifth terminal 16b are disposed at appropriate positions and in appropriate shapes, and thus it is possible to realize fitting between the holder 20 and the sensor 10, and contact between the first terminal 26a and the fourth terminal 16a, and contact between the second terminal 26b and the fifth terminal 16b with a simple operation.

### 1.6 First Terminal and Second Terminal

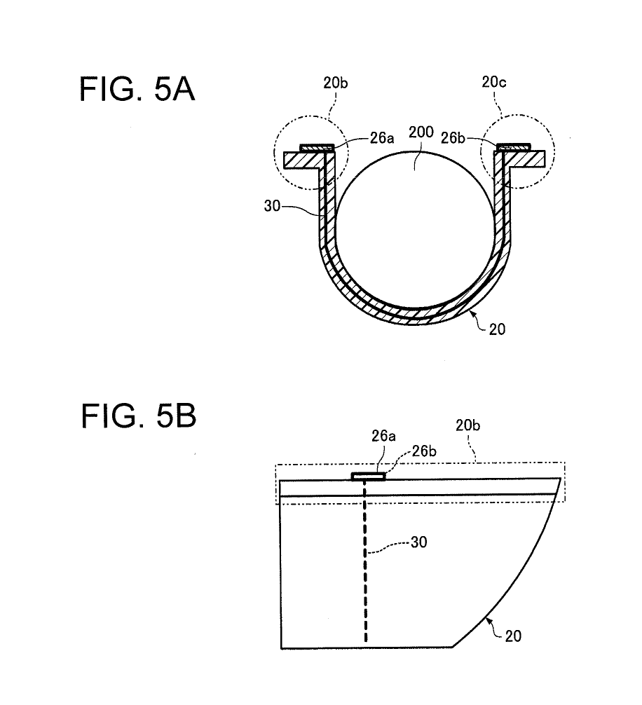

FIGS. 5A and 5B are schematic diagrams illustrating examples of the first terminal 26a, the second terminal 26b, and the wiring 30 provided in the holder 20 according to the present embodiment. FIG. 5A is a schematic sectional view in which the holder 20 is cut in a direction perpendicular to a direction in which the golf club 200 extends, and FIG. 5B is a schematic diagram viewed from a direction in which the pair of opening ends of the holder 20 overlap each other.

The holder 20 includes the first terminal 26a and the second terminal 26b. The first terminal 26a and the second terminal 26b are respectively formed at the fitting portion 20b and the fitting portion 20c of the holder 20. In the illustrated example, the first terminal 26a is provided in a planar shape on the surface of the rail-shaped fitting portion 20b of the holder 20, and the second terminal 26b is provided in a planar shape on the surface of the fitting portion 20c. The first terminal 26a and the second terminal 26b may have planar shapes, and may have probe shapes so that contact portions with the fourth terminal 16a and the fifth terminal 16b are formed in dot shapes. If the wiring 30 to be described later is made of a linear material, end surfaces of the linear surface may be used as the first terminal 26a and the second terminal 26b.

The first terminal 26a and the second terminal 26b are electrically connected to the wiring 30, and are thus electrically connected to each other. The connection between the first terminal 26a and the second terminal 26b, and the wiring 30 is not particularly limited, and may be performed through integral formation, and may be performed through only mechanical contact. The first terminal 26a and the second terminal 26b, and the wiring 30 may be manufactured by disposing the holder 20 in a mold and molding the holder 20 in a state in which the terminals and the wiring are joined to each other in advance through crimping.

Shapes of the first terminal 26a and the second terminal 26b are not limited as long as electrical connection with the fourth terminal 16a and the fifth terminal 16b is ensured. In the illustrated example, the first terminal 26a and the second terminal 26b have circular shapes in a plan view. Thicknesses of the first terminal 26a and the second terminal 26b are not also limited in the same manner, and may be set as appropriate so as to match an aspect of mechanical coupling between the holder 20 and the sensor 10.

As illustrated in FIGS. 4, 5A, 5B, 11 and 12, and the like, the first terminal 26a and the second terminal 26b are provided on the rail-shaped fitting portions 20b and 20c and have disc shapes. A size of the contact surface of the disc is not particularly limited. However, if sizes of contact points with the fourth terminal 16a and the fifth terminal 16b are too small, conduction may hardly occur even in a case where the holder 20 and the sensor 10 are appropriately attached (so that the first terminal 26a and the second terminal 26b are respectively electrically connected to the fourth terminal 16a and the fifth terminal 16b). If the sizes of the contact points with the fourth terminal 16a and the fifth terminal 16b are too large, conduction may occur even in a case where the holder 20 and the sensor 10 are not appropriately attached.

If areas of the contact portions between the first terminal 26a and the second terminal 26b, and the fourth terminal 16a and the fifth terminal 16b are in the above-described extent when the holder 20 and the sensor 10 are appropriately attached, in a case where fitting between the fitting portion 20b and the groove 11d is sufficient (appropriate), the first terminal 26a and the second terminal 26b can be brought into contact with the fourth terminal 16a and the fifth terminal 16b, and a determination that the holder 20 and the sensor 10 are appropriately attached can also be easily performed. There is an advantage in that wrong contact or poor contact caused by some disturbance (the presence of a foreign substance, corrosion of the terminal surface, or the like) in the contacts between the first terminal 26a and the second terminal 26b, and the fourth terminal 16a and the fifth terminal 16b can be reduced. Consequently, a determination criterion and an allowable range of whether or not attachment (assembly) is favorably performed are properly set, and thus it is possible to call a user's attention and also to prevent putting an excessive load on the user.

Materials of the first terminal 26a and the second terminal 26b are not particularly limited as long as the materials are conductive, but may include metals such as gold, nickel, copper, SUS, and aluminum.

### 1.7 Fourth Terminal and Fifth Terminal

The sensor 10 includes the fourth terminal 16a and the fifth terminal 16b. The fourth terminal 16a and the fifth terminal 16b are formed at portions of the sensor 10 which are fitted to the holder 20. In the illustrated example, the terminals are formed in planar shapes inside the groove 11d and the groove 11e of the sensor 10. The fourth terminal 16a and the fifth terminal 16b may have planar shapes, and may have probe shapes so that the contact portions with the first terminal 26a and the second terminal 26b are formed in dot shapes.

The fourth terminal 16a and the fifth terminal 16b are electrically connected to the determination unit 140 provided in the sensor 10. Connection between the fourth terminal 16a and the fifth terminal 16b, and the determination unit 140 is not particularly limited, and may be performed by using a wiring or the like as appropriate. Shapes of the fourth terminal 16a and the fifth terminal 16b are not limited as long as electrical connection with the first terminal 26a and the second terminal 26b can be ensured. In the illustrated example, both of the fourth terminal 16a and the fifth terminal 16b have circular shapes in a plan view. Thicknesses of the fourth terminal 16a and the fifth terminal 16b are not also limited.

As illustrated in FIGS. 7 and 10, the fourth terminal 16a and the fifth terminal 16b are provided at the groove 11d and the groove 11e and are formed in disc shapes. Materials of the fourth terminal 16a and the fifth terminal 16b are not particularly limited as long as the materials are conductive, but may include metals such as gold, nickel, copper, SUS, and aluminum.

### 1.8 Wiring

The holder 20 includes the wiring 30 which is electrically connected to the first terminal 26a and the second terminal 26b. In other words, the wiring 30 is provided in the holder 20, and electrically connects the fourth terminal 16a and the fifth terminal 16b of the sensor 10 to each other via the first terminal 26a and the second terminal 26b when the sensor 10 is appropriately connected to the holder 20. The wiring 30 is electrically connected to the first terminal 26a and the second terminal 26b, and the determination unit 140 of the sensor 10 can determine whether or not fitting between the holder 20 and the sensor 10 is appropriately performed on the basis of whether or not the first terminal 26a and the second terminal 26b are respectively connected to the fourth terminal 16a and the fifth terminal 16b via the wiring 30.

The wiring 30 is connected to the first terminal 26a and the second terminal 26b provided at the pair of ends of the holder 20, and is thus disposed so as to surround the golf club 200 when attached to the golf club 200. A length of the wiring 30 is not particularly limited. A shape of the wiring 30 is not also particularly limited, but may be, for example, a linear shape (refer to each drawing), a planar shape, or a net shape. The wiring 30 may be provided in a plurality, and a plurality of terminals may be provided which are connected to the respective wiring 30 so as to correspond thereto. In this case, if a plurality of corresponding terminals are provided in the sensor 10, it is possible to determine whether or not connection between the holder 20 and the sensor 10 is appropriately performed at a plurality of locations.

The wiring 30 may be formed along the surface of the holder 20, and may be formed so as to be embedded inside the holder 20 (so as to be covered with a material forming the holder 20). The wiring 30 is embedded in the holder 20, and thus it is possible to minimize deterioration such as rust on the wiring 30. The wiring 30 is embedded in the holder 20, and thus it is possible to prevent disconnection of the wiring 30 due to an external force or the like.

Materials of the wiring 30 are not particularly limited as long as the materials are conductive, but may include metals such as gold, nickel, copper, SUS, and aluminum. As a material of the wiring 30, a transparent conductor such as ITO may be used. As described above, the wiring 30 may be used as a direction indicator which indicates an attachment direction of the holder 20 to an exercise appliance (golf club 200) to a user. In this case, it is possible to achieve an effect of further increasing visibility of the direction indicator by forming the wiring 30 through a combination between the transparent conductor and a metal.

### 1.9 Operations and Effects

In the holder 20 according to the present embodiment, it is possible to easily determine whether or not the holder 20 and the sensor 10 are appropriately attached to an object to be measured (golf club 200) by checking conduction by using the first terminal 26a and the second terminal 26b. For example, it is possible to determine whether or not the holder 20 and the sensor 10 are appropriately attached to an object to be measured (golf club 200) (attached so that the first terminal 26a and the second terminal 26b are respectively appropriately electrically connected to the fourth terminal 16a and the fifth terminal 16b) by determining conduction between the first terminal 26a and the second terminal 26b with the sensor 10. For example, if a potential difference occurs between the first terminal 26a and the second terminal 26b when attachment is favorable, and a light emitting diode or the like is turned on due to a related potential difference, it is possible to notify a user that the holder 20 and the sensor 10 are appropriately attached to the object to be measured (golf club 200) through turning-on of the light emitting diode.

Consequently, the user can check whether or not the sensor 10 is reliably attached to the object to be measured, and thus the user can easily check whether or not attachment is favorably performed. Thus, it is possible to hardly cause dropping-out or a positional deviation of the sensor 10 or the holder 20 during using of the object Lo be measured.

### 2. Sensor Set

The sensor set 100 according to the present embodiment includes the above-described wiring 30 which is provided in the above-described holder 20 and is connected to the first terminal 26a and the second terminal 26b, and the above-described sensor 10 provided with the fourth terminal 16a and the fifth terminal 16b which respectively come into contact with the first terminal 26a and the second terminal 26b.

The sensor set 100 enables whether or not attachment to an object to be measured is performed to be easily performed. Consequently, a user can easily check whether or not the attachment is favorably performed. Thus, it is possible to hardly cause dropping-out or a positional deviation of the sensor 10 or the holder 20 during using of the object to be measured.

### 3. Modification Examples

The holder 20 and the sensor set 100 of the present embodiment may be variously modified unless the above-described functions are damaged.

### 3.1 Modification Examples of Holder

The holder 20 may include a light emitting body connected to the wiring 30. The light emitting body may include alight emitting diode (LED), a laser diode, and the like. The light emitting body is connected to the wiring 30 as appropriate so as to emit light when a positional deviation occurs between the first terminal 26a and the second terminal 26b. The light emitting body may be connected to the wiring 30 and a ground line (not illustrated) as appropriate so as to emit light according to high and low levels (High and Low) of potentials of the first terminal 26a and the second terminal 26b. In any case, the light emitting body is connected to the wiring so as to be turned on, to be turned off, or to blink when the first terminal 26a and the second terminal 26b are respectively connected to the fourth terminal 16a and the fifth terminal 16b. Specific examples of such connection will be described more in detail in modification examples of the sensor set.

The light emitting body is a notification portion which can notify a user whether or not the holder 20 and the sensor 10 are appropriately attached. If the light emitting body is provided in the holder 20, it is possible to notify the user whether or not attachment is favorably performed through turning-on, turning-off, or blinking of the light emitting body.

A position where the light emitting body is provided in the holder 20 is not particularly limited, but the holder 20 is provided, for example, at a position where a user can easily visually recognize the light emitting body. After the user confirms that attachment is appropriately performed, the light emitting body may be turned off so as not to obstruct a view of the user when the user operates the object to be measured (exercises).

As the light emitting body, a light emitting body which emits light at an operation voltage of the sensor 10, for example, at a voltage such as 3 V, 3.3 V or 5 V. The light emitting body may emit light by using a power source (a battery or the like) for light emission. The power source for light emission may be provided in the sensor 10, and may be provided in the holder 20. Although not illustrated, if the power source for light emission is provided in the holder 20, this contributes to miniaturization and reduction in weight of the sensor 10.

The holder 20 may include a sound generation body as a notification portion, and can also achieve the same effects as in the above-described light emitting body.

### 3.2. Modification Examples of Sensor Set

The sensor 10 of the sensor set 100 of the present embodiment may include the determination unit 140 and a transmission section 132 (which will be described later in detail). If the first terminal 26a and the second terminal 26b respectively come into contact with the fourth terminal 16a and the fifth terminal 16b, the determination unit 140 may determine that the sensor 10 and the holder 20 are appropriately attached, and may transmit information regarding whether or not the sensor 10 and the holder 20 are attached, via the transmission section 132 on the basis of the related determination result. In other words, in the sensor set 100, the transmission section 132 provided in the sensor 10 may be used as a notification portion for a user. Consequently, it is possible to notify the user of a determination result by using sound, light, display, or the like from an external apparatus such as a portable terminal which receives related information.

The sensor 10 may include a light emitting body which is turned on, turned off, or blinks according to a determination result from the determination unit 140. The light emitting body is the same as the above-described light emitting body provided in the holder 20, and thus description thereof will be omitted. If the light emitting body is provided in the sensor 10, it is possible to notify the user whether or not attachment is favorably performed through turning-on, turning-off, or blinking of the light emitting body. A power source (a battery or the like) of the sensor 10 may be provided in the sensor 10 but may be provided in the holder 20. In a case where the power source of the sensor 10 is provided in the holder 20, the first terminal 26a, the second terminal 26b, the fourth terminal 16a, and the fifth terminal 16b described above may be used as terminals for supplying power to the sensor 10 from the holder 20 when the sensor 10 is attached to the holder 20, and a plurality of terminals may be provided separately. It may be determined whether or not the sensor 10 and the holder 20 are appropriately attached on the basis of connection states of the terminals.

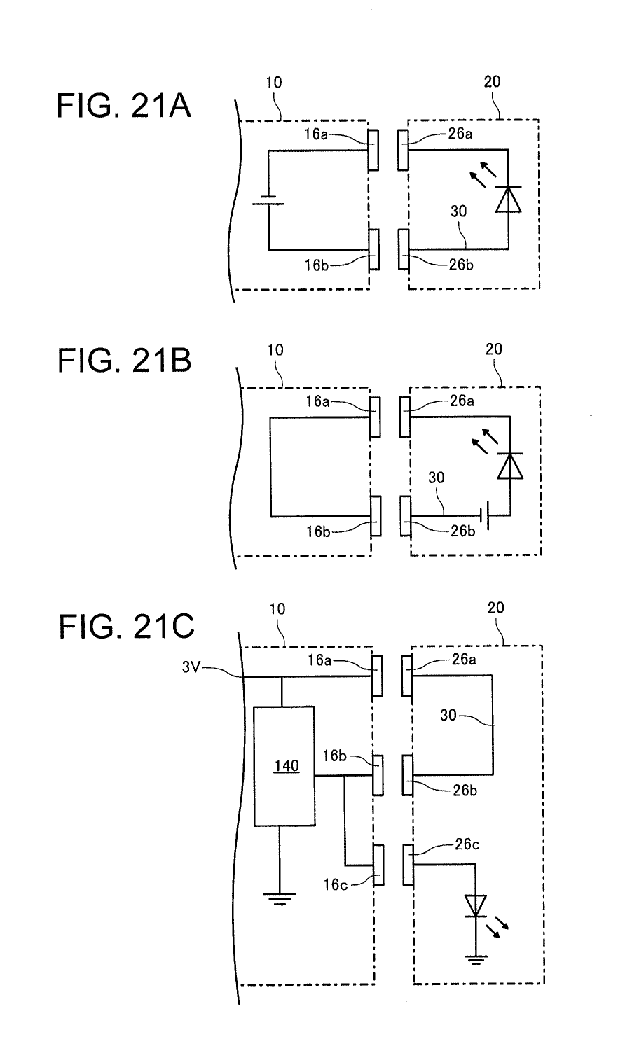

FIGS. 21A to 21C are diagrams schematically illustrating circuits in a case where a light emitting diode is provided in the holder 20 of the sensor set 100 as a light emitting body. In an example illustrated in FIG. 21A, the light emitting diode is connected in series to the wiring 30. A battery for turning on the light emitting diode is provided in the sensor 10, and causes a potential difference between the fourth terminal 16a and the fifth terminal 16b. In this example, if the sensor 10 is appropriately connected to the holder 20, the first terminal 26a and the fourth terminal 16a come into contact with each other, and the second terminal 26b and the fifth terminal 16b also come into contact with each other. Therefore, the potential difference caused by the battery provided in the sensor 10 is applied to the light emitting diode, and thus the light emitting diode is turned on.

In the example illustrated in FIG. 21B, the light emitting diode and the battery are connected in series to the wiring 30. In this example, if the sensor 10 is appropriately connected to the holder 20, the first terminal 26a and the fourth terminal 16a come into contact with each other, and the second terminal 26b and the fifth terminal 16b also come into contact with each other. Therefore, the potential difference caused by the battery is applied to the light emitting diode, and thus the light emitting diode is turned on.

In the example illustrated in FIG. 21C, a third terminal 26c is provided in the holder 20, and a sixth terminal 16c is provided in the sensor 10. The third terminal 26c and the sixth terminal 16c are provided at contact positions when the holder 20 is fitted to the sensor 10. Shapes, materials, and the like of the third terminal 26c and the sixth terminal 16c are the same as those of the first terminal 26a and the fourth terminal 16a, and the like. The third terminal 26c is connected to a ground line via the light emitting diode. The third terminal 26c may be provided on one end side of the opening end of the holder 20. The sixth terminal 16c is connected to the fourth terminal 16a in the sensor 10. The sixth terminal 16c may be provided at a position corresponding to the third terminal 26c of the sensor 10.

In this example, a power source for turning on the light emitting diode is common to a power source of the sensor 10, and the light emitting diode is turned on due to a potential difference with the ground line. The ground line is not particularly limited, and may employ coating or the like of the holder 20 and the sensor 10. A pair of terminals (not illustrated) may be added to the sensor 10 and the holder 20 and may be used as the ground line.

In this example, if the sensor 10 is appropriately connected to the holder 20, the first terminal 26a and the fourth terminal 16a come into contact with each other, the second terminal 26b and the fifth terminal 16b come into contact with each other, and the third terminal 26c and the sixth terminal 16c come into contact with each other. Therefore, a potential of the power source of the sensor 10 is applied to the light emitting diode, and thus the light emitting diode is turned on. In this example, since the third terminal 26c and the sixth terminal 16c are provided and thus a potential (3 V) of the sensor 10 side can be applied to the light emitting diode, the light emitting diode is turned on when all the sets of terminals come into contact with each other. Consequently, it is possible to determine attachment of the holder 20 and the sensor 10 more accurately.

### 4. Exercise Appliance with Sensor

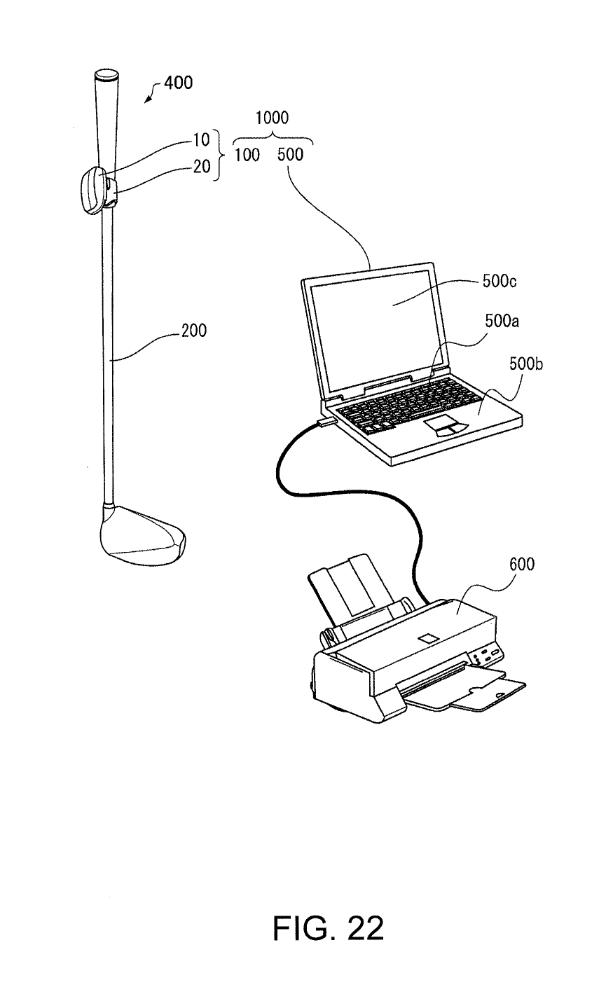

An exercise appliance 400 with sensor according to the present embodiment is an exercise appliance such as the golf club 200, and is attached with the above-described sensor set 100 (refer to FIG. 3 or 22). The exercise appliance 400 with sensor can easily determine whether or not fitting between the sensor 10 and the holder 20 is favorably performed, and can call a user's attention on the basis of a related determination, and thus it is possible to prevent the sensor 10 or the holder 20 from being dropped out during using.

### 5. Motion Analysis Apparatus

FIG. 22 is an exterior view illustrating a motion analysis apparatus according to the present embodiment. As illustrated in FIG. 22, a motion analysis apparatus 1000 (hereinafter, referred to as an analysis apparatus 1000) according to the present embodiment includes the above-described sensor set 100, and a computer 500 which acquires motion data of the golf club 200 as an object to be measured, obtained by the sensor set 100, and analyzes the motion data. The computer 500 includes a processing unit 500b provided with an input section 500a, and a display unit 500c which displays a processing result. In the illustrated example, the personal computer 500 (hereinafter, referred to as a PC 500) is provided, but a portable terminal such as a tablet terminal or a smart phone may be connected to the sensor set 100 in a wireless manner. A printer 600 may be provided as an external output apparatus for recording an analysis result in the PC 500. In the present embodiment, data is transmitted and received between the sensor set 100 and the PC 500 via wireless communication.

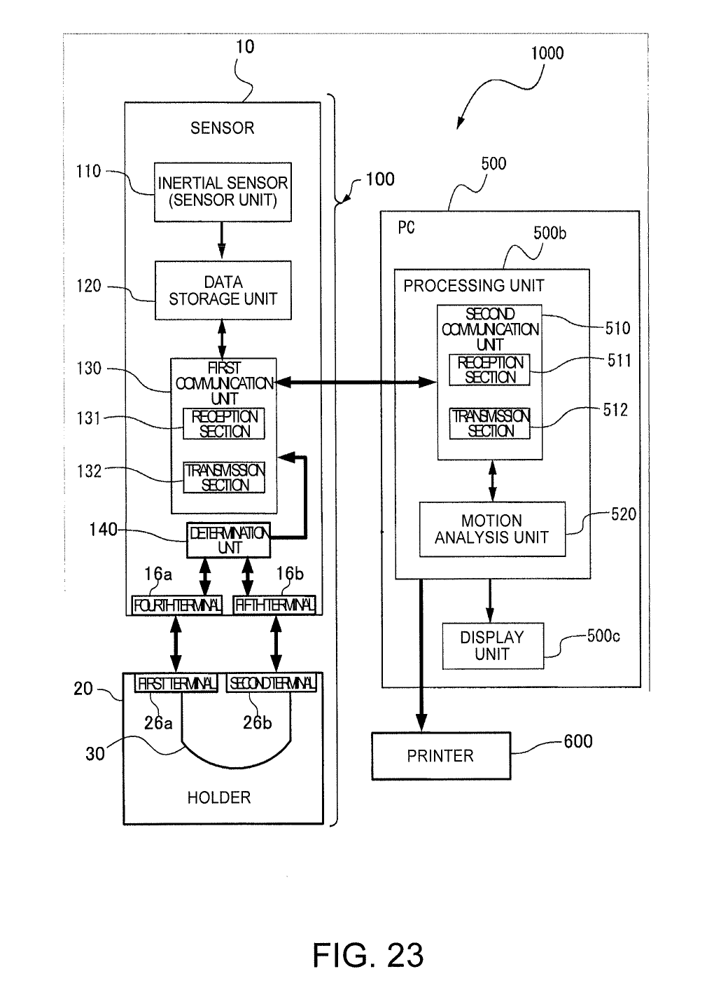

FIG. 23 is a block diagram of the analysis apparatus 1000 illustrated in FIG. 22. As illustrated in FIG. 23, the sensor 10 provided in the sensor set 100 includes at least an inertial sensor 110 (sensor unit), a data storage unit 120 which stores data while processing the data, and a first communication unit 130 including the transmission section 132 which transmits data to the PC 500 and a reception section 131 which receives data from the PC 500. The PC 500 provided in the analysis apparatus includes the processing unit 500b and the display unit 500c as described above. The processing unit 500b is provided with a second communication unit 510 including a reception section 511 which receives data transmitted from the first communication unit 130 of the sensor 10, and a transmission section 512 which transmits an electric wave to the first communication unit 130, and a motion analysis unit 520 which processes and analyzes acquired detection data. The display unit 500c displays an analysis result in the motion analysis unit 520. The printer 600 as an external output apparatus of the analysis result is provided.

As an example of an operation of the analysis apparatus 1000, a description will be made of a case where the PC 500 notifies a user of information regarding whether or not the holder 20 and the sensor 10 are favorably attached. First, the holder 20 and the sensor 10 are attached to the golf club 200, and the determination unit 140 determines whether or not the first terminal 26a and the fourth terminal 16a come into contact with each other, and the second terminal 26b and the fifth terminal 16b come into contact with each other (or whether or not electrical connection with the fourth terminal 16a and the fifth terminal 16b occurs). A determination result in the determination unit 140 is transmitted from the first communication unit 130 to the second communication unit 510. Whether or not the holder 20 and the sensor 10 are appropriately attached is displayed on the display unit 500c on the basis of the information received by the second communication unit 510, and thus the user is notified thereof. A notification may be performed by using sound from a sound generation body (an alarm device). In a case where a related notification indicates that the holder 20 and the sensor 10 are inappropriately attached, the user is prompted to check attachment of the holder 20 and the sensor 10 and to attach the holder 20 and the sensor 10 again as necessary. On the other hand, in a case where the attachment is favorable, a notification of the favorable attachment is sent to the user. Alternatively, in a case where the attachment is favorable, the favorable attachment may be notified by not performing display or alarming. In a case where an LED is provided in the sensor 10 or the holder 20, a notification may be performed by using a plurality of notification portions.

If the user recognizes that the attachment of the holder 20 and the sensor 10 is favorable, and swings the golf club 200 attached with the sensor set 100, the inertial sensor 110 detects an inertial force, and transmits the detection data to the data storage unit 120. The data storage unit 120 processes the data in a data format which can be transmitted to the PC 500 and accumulates (stores) the data until receiving a transmission instruction from the PC 500. After a predetermined swing for motion analysis is completed, a motion analysis operation is started. If an analysis starting command is given to the processing unit 500b via the input section 500a (not illustrated), an instruction for transmission of detection data is transmitted from the transmission section 512 of the second communication unit 510 to the first communication unit 130 in a wireless manner. A related radio wave is received, and the detection data stored in the data storage unit 120 is transmitted to the processing unit 500b from the transmission section 132 by using a radio wave on the basis of the command transmitted to the reception section 131 of the first communication unit 130.

The detection data received by the reception section 511 of the second communication unit 510 is transmitted to the motion analysis unit 520, and motion analysis of the golf club 200 is performed on the basis of a predetermined analysis program. An analysis result is displayed as an image on the display unit 500c of the PC 500, or is recorded on a recording medium and is output by the printer 600 as an external output apparatus.

Since the motion analysis apparatus 1000 according to the present embodiment includes the above-described sensor set 100, attachment to an object to be measured (for example, the golf club 200) is easily performed, and it can be easily determined whether or not fitting to the rail and the groove is reliably performed. Consequently, the user can check whether or not attachment is favorably performed. Therefore, it is possible to hardly cause dropping-out or a positional deviation of the sensor.

Since the sensor is not attached to an object to be measured by using an adhesive member, it is possible to reduce analysis preparation time and to easily detach the sensor from the object to be measured after an analysis is completed, and also to reduce analysis time and to prevent dirt such as an adhesive from being attached to the object to be measured. Therefore, it is possible to analyze motion characteristics of the object to be measured without reducing a commercial value of the object to be measured.

The invention is not limited to the above-described embodiment, and may be further variously modified. For example, the invention includes substantially the same configuration (for example, a configuration in which functions, methods, and results are the same) as the configuration described in the embodiment. The invention includes a configuration in which an inessential part of the configuration described in the embodiment is replaced with another part. The invention includes a configuration which achieves the same operation and effect or a configuration capable of achieving the same object as in the configuration described in the embodiment. The invention includes a configuration in which a well-known technique is added to the configuration described in the embodiment.

The entire disclosure of Japanese Patent Application No. 2014-229769, filed Nov. 12, 2014 is expressly incorporated by reference herein.

What is claimed is:

1. A motion detection device comprising:
a sensor that detects a motion; and
a holder that attaches the sensor to an object to be measured,
wherein the holder is provided with a first terminal and a second terminal that are electrically connected to the sensor when the sensor is attached, and a wiring that connects the first terminal to the second terminal.

2. The motion detection device according to claim 1,
wherein the holder includes a notification unit, and
wherein the notification unit sends a notification of an attachment state of the sensor.

3. The motion detection device according to claim 2,
wherein the notification unit changes a notification due to a potential difference between the first terminal and the second terminal when the sensor is attached.

4. The motion detection device according to claim 2,
wherein the notification unit sends a notification of the attachment state of the sensor through light emission.

5. The motion detection device according to claim 1,
wherein the sensor includes a determination unit that determines a conduction state with the holder when attached to the holder and a communication unit that transmits a result of the determination to an external device.

6. The motion detection device according to claim 1,
wherein each of the sensor and the holder includes fitting portions which are fitted to each other.

7. The motion detection device according to claim 6,
wherein the holder is fastened when the sensor is fitted thereto, and is thus fixed to the object to be measured.

8. The motion detection device according to claim 6,
wherein the sensor is electrically connected to the holder when the sensor and the holder are fitted to each other by the fitting portions.

9. A motion detection device comprising:
a sensor that detects a motion; and
a holder that attaches the sensor to an object to be measured,
wherein at least one of the sensor and the holder is provided with a notification unit that sends a notification of an attachment state of the sensor and the holder.

10. An exercise appliance attached with the motion detection device according to claim 1.

11. An exercise appliance attached with the motion detection device according to claim 2.

12. An exercise appliance attached with the motion detection device according to claim 3.

13. An exercise appliance attached with the motion detection device according to claim 4.

14. An exercise appliance attached with the motion detection device according to claim 5.

15. An exercise appliance attached with the motion detection device according to claim 6.

16. An exercise appliance attached with the motion detection device according to claim 7.

17. An exercise appliance attached with the motion detection device according to claim 8.

18. An exercise appliance attached with the motion detection device according to claim 9.
